(19) United States
(12) Patent Application Publication
(10) Pub. No.: US 2026/0041035 A1
(43) Pub. Date: Feb. 12, 2026

(54) AGRICULTURAL SENSOR CLEANING APPARATUS

(71) Applicant: DEERE & COMPANY, MOLINE, IL (US)

(72) Inventors: NIKHIL ANANDWADE, KOLHAPUR (IN); Nathan R. Vandike, Geneseo, IL (US); PALLAVI BHARGAVA, Dhar (IN)

(21) Appl. No.: 18/797,568

(22) Filed: Aug. 8, 2024

(51) Int. Cl. A01D 41/127; B08B 1/00

(52) U.S. Cl. CPC A01D 41/1276; B08B 1/00

(57) ABSTRACT

In one aspect of the invention, an agricultural machine is provided. The agricultural machine may be configured to perform a function that results in material flow through the machine, which may result in at least one obscurant in the machine. The machine may further include sensor(s) exposed to the obscurant and a sensor cleaning mechanism. The sensor cleaning mechanism may include at least one spring configured to extend and retract and at least one cleaning material. The spring may be configured to move the cleaning material across a surface of the sensor during extension and/or retraction of the spring. In some embodiments, flow of material through the machine may cause the spring, and therefore the cleaning material, to extend across the sensor surface. The spring and cleaning material may retract when material flow is reduced and/or stops. The agricultural machine may be an agricultural harvester, such as a combine harvester.

### TECHNICAL FIELD

The present disclosure relates generally to combine harvesters for crop harvesting. More particularly it relates to methods and devices for cleaning an agricultural sensor.

### BACKGROUND

Combines, or sometimes combine harvesters or harvesters, serve to harvest crop(s), such as at the end of an agricultural season. Combines are so named because they combine several tasks necessary to process a crop, such as a grain crop, at harvest. For example, a combine may cut, thresh, and clean the crop. A combine may include several subsystems, including, but not limited to, a header or implement, a threshing section, a separating section, a cleaning shoe, a tailings section, a clean grain tank, and a residue handling section. Each of these subsystems may in turn include several components. A combine operator may operate the combine from an operator station, such as a cabin or cab. The combine may include one or more sensors for one or more purposes. In some implementations, a sensor may include a camera. In some implementations, a camera may be used to display a view to an operator, whether local or remote to the combine. In other implementations, a camera may be used to provide input to a controller. During agricultural operations, obscurant, including but not limited to dust and debris, may obscure the sensor and/or its output.

### SUMMARY

Provided is an agricultural machine. The agricultural machine may be configured to perform a function that results in material flow in a first direction through the agricultural machine. Moreover, the material flow may result in at least one obscurant in the agricultural machine. The agricultural machine may also include at least one sensor that is exposed to the obscurant and a sensor cleaning mechanism. The sensor cleaning mechanism may include at least one spring configured to extend and retract and at least one cleaning material. The spring may be configured to move the cleaning material across a surface of the sensor during at least one of extension and retraction of the spring.

In some implementations, the spring may extend in the first direction and retract in a second, opposite direction. Moreover, the material flow in the first direction may cause the spring to extend in the first direction. Stopping or reducing the material flow in the first direction may cause the spring to retract in the second direction. In other implementations, material flow in the first direction may cause the spring to retract in the first direction. A bracket may join the sensor and the spring. The sensor cleaning mechanism may include a plurality of springs. The sensor cleaning mechanism may further include a plurality of brackets that each join at least one of the plurality of springs to the sensor. In some implementations, the sensor cleaning mechanism may include two springs that each have a first end and a second end. The first ends may be joined to first and second brackets, respectively, and the cleaning material may extend between the second ends of the springs.

The agricultural machine may be an agricultural harvester, such as a combine harvester.

### BRIEF DESCRIPTION OF THE DRAWINGS

The detailed description of the drawings refers to the accompanying figures.

FIG. 1 is a side elevation view of an implementation of a combine harvester.

FIG. 2 is a block diagram of an embodiment of a cleaning control apparatus of the present invention.

FIG. 3 is a flowchart of an embodiment of a method for cleaning an agricultural sensor of the present invention.

FIG. 4 is a perspective view of an implementation of a cleaning apparatus of the present invention.

Like reference numerals are used to indicate like elements throughout the several figures.

### DETAILED DESCRIPTION

The following is a detailed description of one or more embodiments of technology, including systems, methods, and apparatuses, for cleaning a sensor of an agricultural machine.

As used herein, “e.g.” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Moreover, sometimes terms such as “above,” “below,” “upward,” “downward,” “top,” “bottom,” etc., will also be used in connection with describing an agricultural machine as it is oriented when it sits on the ground in its customary operating mode. However, these terms are again used for description purposes and do not represent limitations on the scope of the disclosure, unless required by the claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

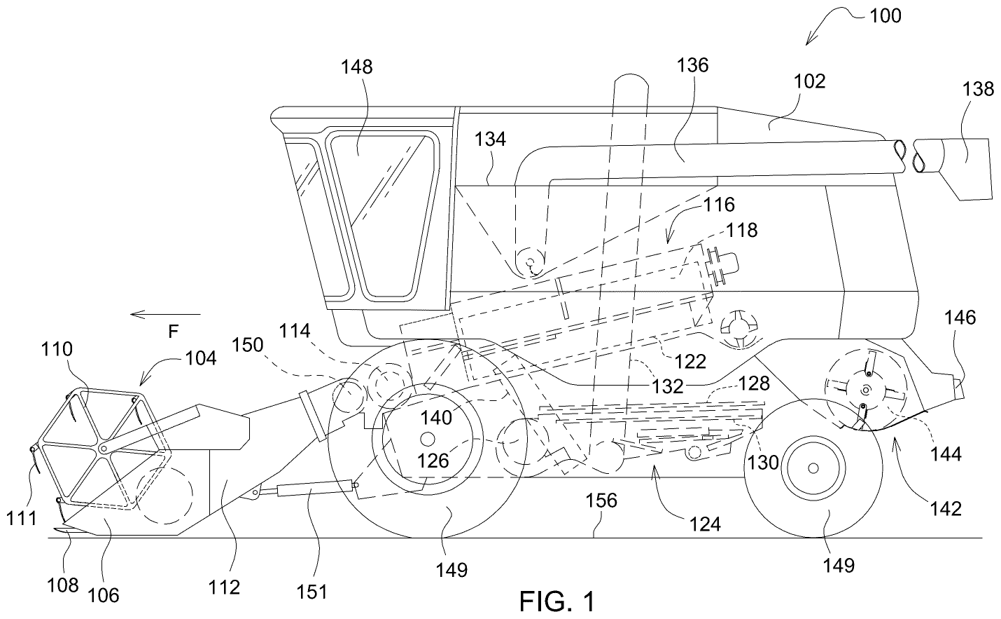

Referring to FIG. 1, an exemplary agricultural harvester 100 (sometimes “harvester” or “combine harvester” or “combine”) is shown. The illustrated harvester 100 serves to cut and process crop products, including but not limited to grains, from a field. In some embodiments, the agricultural harvester 100 is configured to move in a forward direction of travel F through a crop field to harvest plants, such as crops planted in rows. The illustrated agricultural harvester 100 is a combine harvester. As noted above, combine harvesters are so named because they combine two or more tasks associated with harvesting a crop. The illustrated harvester shows components associated with at least the following tasks: gathering crop, severing or cutting crop, threshing, separating crop products (e.g., grain) from crop residue (e.g., material other than grain), cleaning (or further separating) crop products, processing tailings, and processing crop residue. However, agricultural harvesters having fewer, more, and/or different functions are included in the scope of this invention.

Referring to the gathering and severing functions, harvester 100 may include an implement 104 (sometimes called a head or header) including a gathering section and a cutting section to gather and cut crop, respectively. FIG. 1 illustrates a harvester 100 having a draper head 106, which is typically suited for harvesting crops such as small grains (e.g., wheat, barley), large grains (e.g., soybeans, peas, beans), grasses, and pulse crops (e.g., lentils). Other types of non-illustrated implements may be used without departing from the scope of this invention, including but not limited to a corn head. The illustrated draper head 106 includes a cutter 108 and reel 110 which serve to sever and gather crops, respectively. The reel 110, illustrated as having a plurality of tines 111, engages the crop to be cut and gathers it toward the cutter 108. In the draper head of FIG. 1, the cutter 108 may include one or more knives or blades (not shown). The cut portions of the crop may be moved towards a feeder house 112, which may be located near the center of the implement 104. Movement towards the feeder house 112 may be via one or more conveyer belts, augers, or other means (not shown). The cut portions of the crop may be moved from the feeder house 112 to a feed accelerator 114 and into the body 102 of the combine.

The cut portion of the crop may include grain and material other than grain. When the cut portion of the crop enters the body 102, the grain may be attached to the material other than grain or a portion thereof. In the body of the combine, the cut portions of the crop are first introduced to a threshing section or thresher 116. The threshing section 116 removes the grain from the portion of the plant to which it is attached (e.g., the threshing section may separate one or more corn kernels from a cob or one or more soybeans from a pod). Once the grain is detached, the material other than grain may be referred to as residue or crop residue. The threshing section 116 typically includes a rotor 118 with a plurality of threshing projections extending therefrom. The cut material may move through a separating section 122 to separate threshed grain from material other than grain.

After the separating section 122, grain typically moves through a cleaning section, sometimes referred to as a cleaning shoe, 124. The cleaning section 124 may include a cleaning fan 126, chaffer 128, and a sieve 130 which work in combination to separate grain from comparatively similar sized pieces of crop residue that were not separated from the grain in the separating section 122. After the cleaning section 124, grain may either be clean, in which case it follows the path of clean grain, or it may require further processing. If grain is clean, it moves to a clean grain elevator 132, which may be any type, including but not limited to an auger or a conveyer. The clean grain elevator 132 moves clean grain to a clean grain tank 134. The clean grain may be moved from the clean grain tank 134 via an unloading auger 136 and spout 138. On the other hand, the grain may require further processing, such as in the case of incompletely threshed grain. Such grain requiring further processing after the cleaning section 124 is commonly referred to as tailings. The tailings may move to the tailings elevator 140, which may be any type, including but not limited to an auger or a conveyer. The tailings elevator 140 may move the tailings back to the threshing section 116 to be further processed. Alternatively, in some harvesters a separate tailings section (not shown) may further thresh and process the tailings. Crop residue may move through a residue handling section 142, which may include a chopper 144 and spreader 146. The residue handling section 142 ultimately discharges crop residue out of the harvester 100 back onto the field via the spreader 146.

The harvester 100 components associated with gathering and severing crops are typically housed on implement 104. The remaining functions of the harvester 100 are typically housed in the body 102 of the harvester. The body 102 of the harvester may also include an operator station 148, engine (not shown), and ground engaging mechanism, such as one or more wheels 149 or one or more track assemblies (not shown). The ground engaging mechanism(s) are configured to engage and travel over the ground 156. The harvester 100 may also include a control system, which may be housed anywhere (including in multiple locations). Often, the control system may be accessed by an operator. Such a control system may be accessible by an operator in the operator station and/or a remote operator or other remote individual. The implement 104 may be selectively removable from the body 102 of the harvester. The implement 104 may be pivotable with respect to the body 102, such as via pivot 150. The pivoting movement may be aided by at least one implement support 151 which in the illustrated embodiment is a hydraulic support but may be of any type. To that end, implements, sometimes called headers or heads, may be interchangeable. Therefore, the same harvester 100 may be used to harvest a plurality of crops and crop products. For example, implements may include, but are not limited to, corn heads and draper heads.

Further disclosed are methods, systems, and devices for cleaning an agricultural sensor, including but not limited to an agricultural sensor located on an agricultural harvester. A combine harvester 100, such as that shown in FIG. 1, may include one or more sensors. Examples of sensors may include, but are not limited to, visible light cameras, near-visible light cameras, infrared cameras, optical cameras, thermal imaging cameras, ultrasonic sensors, radar, radar-based cameras, hyperspectral cameras, and light imaging detection and radiation (LIDAR) sensors, among others. Such sensors may include at least one transmission surface through which light, sound waves, images, signals, or combinations thereof, pass through, and are captured or otherwise received by the sensor in connection with the sensor capturing information. Examples of such transmission surfaces include, but are not limited to, a lens, cover, protective film, or shield. At least one side of the transmission surface may be positioned to be in contact with, or exposed to, obscurant, including but not limited to, crop residue, dust, dirt, debris, and water.

Sensor(s) can be located at a variety of positions on an agricultural machine, such as combine 100, including within or along exterior portions of the machine and within the machine. For example, referring to combine 100, one or more sensors may be positioned on implement 104, at feeder house 112, feed accelerator 114, within threshing section 116, within separator section 122, within cleaning section 124, within clean grain elevator 132, within clean grain tank 134, at or within unloading auger 136, within tailings section such as at or within tailings elevator 140, and within residue handling section 142. The foregoing list is not intended to be limiting, and sensors included at other locations of a harvester 100 are included within the scope of the invention. In some implementations, agricultural harvesting can result in material that would obscure a sensor, including but not limited to debris and dust. Such obscurant can settle on, stick to, or otherwise obscure one or more sensors and/or the output thereof. This may affect the quality of the output provided by the sensor. In one nonlimiting example, if the sensor is an image sensor, debris can cause the image to be obscured.

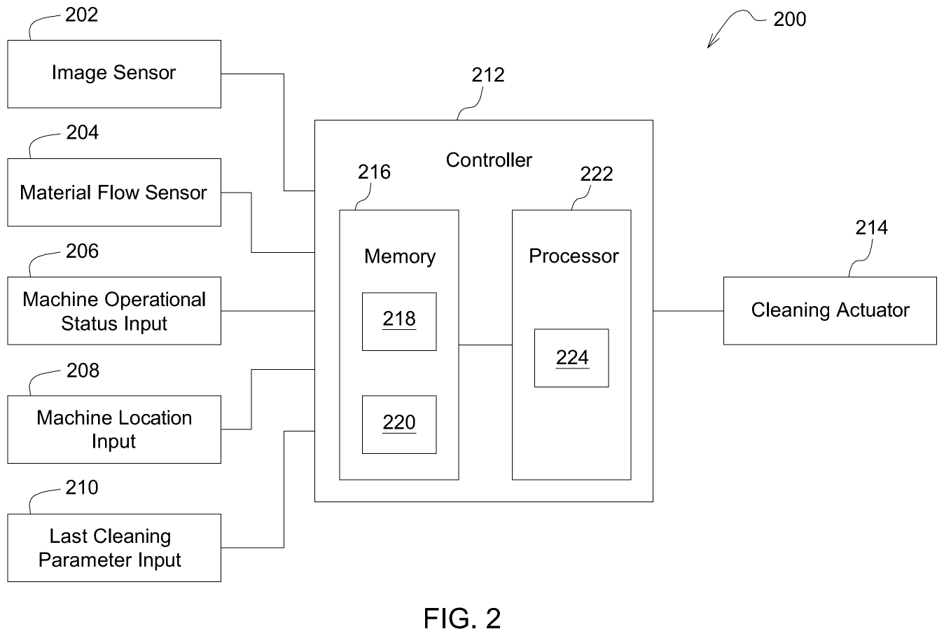

In one or more implementations of the disclosed invention, a cleaning control system 200 is provided to clean a sensor, such as a sensor located on an agricultural harvester, including but not limited to combine 100. Turning to FIG. 2, an implementation of a cleaning control system 200 is provided. The system 200 may include at least one sensor 202. In some implementations, sensor 202 may be an image sensor. Image sensor may include, but is not limited to, a visible light camera, near-visible light camera, infrared camera, optical camera, thermal imaging camera, ultrasonic sensor, radar, radar-based camera, hyperspectral camera, and/or light imaging detection and radiation (LIDAR) sensor. Sensor 202 and/or the output thereof may become obscured during operation of combine 100. System 200 may also include at least one material flow sensor 204. Material flow sensor 204 may be any sensor known now or in the future for detecting a level of material flow at or near its location on combine 100. Material flow sensor 204 may be, but is not limited to, force plate sensors, impact sensors, drive force sensors, material presence sensors (including but not limited to mechanical displacement sensors and light beams), capacitive sensors, and/or other electromagnetic sensors, a visible light camera, near-visible light camera, infrared camera, optical camera, thermal imaging camera, ultrasonic sensor, radar, radar-based camera, hyperspectral camera, and/or light imaging detection and radiation (LIDAR) sensor. Material flow sensor 204 may be configured to detect the level of material moving through combine 100 (including but not limited to obscurant such as dust and debris that may obscure sensor 202 and/or the output of sensor 202) at or near its location on combine 100.

The system may also include machine operational status input 206, which in the illustrated implementation may be combine 100 operational status. Machine operational status input 206 may provide input related to the status of the machine at a given time, including but not limited to, whether the machine is in a harvest state or a non-harvest state, whether the machine is unloading, whether the machine is in a transport mode, etc. Without limitation machine operational status input 206 may be provided by sensors or other information within combine 100 related to positions and/or speeds of various combine 100 components. For example, related to the positions of components, the feeder house 112 may be raised in a non-harvest state and lowered in a harvest state, the unloading auger 136 may be extended in an unloading state and retracted when not unloading, and the grain tank 134 covers may be closed in a transport mode. With respect to speeds or engagements of components, header (sometimes referred to as implement) 104 drives engaged and/or separator drives engaged indicate a harvest state. Unloading auger 136 drives engaged indicate an unloading state. Moreover, the speed of combine 100 may indicate a transport state. In some implementations one or more of the above inputs or sources may be used to determine the machine operational status. In addition, machine operational status input 206 may provide input related to the specific status or stage of a particular operation, for example the status of an unloading operation, etc.

Furthermore, the system 200 may include machine location input 208. Machine location input 208 may provide information related to the location of the machine to the cleaning control system 200. For example, machine location input 208 may provide information related to whether combine 100 is in a field and/or where combine 100 is located within a field to be harvested, such as in an area to be harvested, in an area that has already been harvested, at a boundary, at the headlands, in an area to be harvested where the width of the crops to be harvested is less than the maximum harvestable width of the combine 100 and implement 104, or elsewhere. In some implementations, information related to machine location may be obtained from a GPS signal. In some implementations, information related to machine location may be determined from optical sensors configured to determine the machine location. For example, optical sensors may be useful to determine if the machine is in a field, outside of a field (including but not limited to on a road), in a harvested area, and/or in an unharvested area. In some implementations, the location may be obtained from machine systems related to producing and/or following a field map that has been created by combine 100 and/or loaded into combine 100. Such a field map may include, but is not limited to, a coverage map or a boundary map. In some embodiments, such a field map may include field boundaries, which may indicate whether the machine is inside of a field or outside of a field and/or within a non-crop or unharvestable area of a field, area(s) of the field that have already been harvested, area(s) of the field to be harvested, areas of the field to be harvested wherein the crops to be harvested are less than the maximum harvestable width of combine 100 and implement 104. Other information may be included in a field map without departing from the scope of the invention. In some embodiments, one or more of the above inputs or sources may be used to determine the machine location.

In addition, the system 200 may include at least one input related to one or more parameters related to the last cleaning cycle 210. In some implementations, last cleaning parameter input 210 may provide input related to an amount of time since sensor 202 was last cleaned. In some implementations, last cleaning parameter input 210 may provide the amount of material harvested and/or an amount of area harvested since the last cleaning cycle. Other parameters may provided without departing from the scope of the invention.

Sensor 202, material flow sensor 204, machine operational status input 206, machine location input 208, and/or last cleaning parameter input 210 may provide information to controller 212. Controller 212 is configured to receive information and activate a cleaning actuator 214 at appropriate times based upon the received information. Cleaning actuator 214 may be configured to cause a cleaning apparatus to clean sensor 202. Cleaning actuator 214 may be any type of actuator, including but not limited to a linear actuator, rotational actuator, electrical actuator, or hydraulic actuator.

Controller 212 may include a processor 222 and memory 216. The processor 222 may be communicatively coupled to the memory 216. The memory 216 may communicate with the processor 222 and may be used to store programs and other software and information (such as in the form of data). The processor 222 may be operable to execute programs and software and receive information from and send information to the memory 216. Although a single memory 216 and a single processor 222 are illustrated, in other implementations, a plurality of memories, processors, or both may be used. Although the processor 222 and memory 216 are shown as being local components of the controller 212, in other implementations, one or both of the processor 222 and memory 216 may be located remotely.

The memory 216 stores data, including but not limited to, image data, material flow data, machine operation status data, machine location data, data related to the last cleaning parameter(s) (collectively, “input data” 218). Memory 216 may also store cleaning control module instructions 220. Processor 222 may execute programs. Such programs may include, but are not limited to, cleaning control module 224. The controller 212 utilizes the input data 218 to determine whether to instruct cleaning actuator 214 to clean sensor(s), such as image sensor 202. The memory 216 may include random access memory (RAM) or other dynamic storage devices for storing information and instructions and/or read only memory (ROM) or other static storage devices for storing static information and instructions. The memory 216 may be a non-transitory, non-volatile memory device and operable to store information, such as data, and instructions executable by the processor 222. In some implementations, the processor 222 executes the cleaning control module 224, which uses the input data 218 to determine whether to instruct cleaning actuator 214 to clean sensor 202.

With respect to receiving and sending information, controller 212 may include an input/output (not shown) for receiving input signals and providing output signals. The controller 212, such as a communication interface (not shown), may be operatively coupled to a network.

As indicated above, the cleaning control system 200 includes or is communicably coupled to at least one cleaning actuator 214. The actuator(s) 214 are associated with a cleaning apparatus for at least one sensor 202. Exemplary cleaning apparatuses may include, but are not limited to, cleaning apparatuses controlled by actuators that wipe and/or scrape the sensor (e.g., a motor driven mechanism), a fluid washing apparatus, such as a nozzle that emits pressurized fluid (e.g. air, water, solvent), a heating element (e.g. blowing warm air and/or a defrosting element associated with the sensor), a vibration apparatus, the application of dust repellent, and/or the application of water repellent.

Processor 222 may execute cleaning control module 224 based on cleaning control module instructions 220 stored on memory 216. In one or more implementations, cleaning control module 224 may be configured to cause activation of the cleaning actuator 214 at a time when the cleaning operation will be needed more than at other times, at a time when the cleaning operation will be more effective than at other times, or both. In one or more implementations, such a time may be when the amount of obscurant (for example, dust or debris) flowing through the machine is lower compared to other times. The controller may be configured to determine such a time. Accordingly, in one or more implementations of the disclosed invention, a method 220 for cleaning an agricultural sensor is provided.

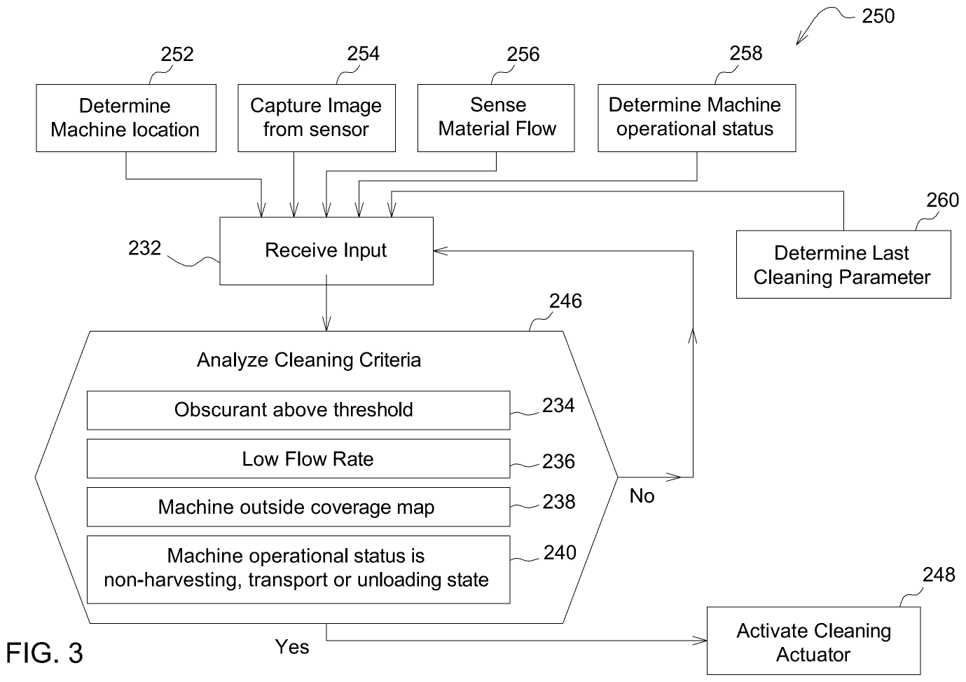

Also provided are methods for cleaning an agricultural sensor. Such a method may include analyzing a flow rate of material through the agricultural machine, such as a combine. The method may further include activating a cleaning actuator to initiate cleaning of a sensor when the flow rate meets at least one predetermined criteria. Analysis of a flow rate may include analyzing one or more criteria that influence the flow rate of material. FIG. 3 provides an example of an implementation of a method 250 for cleaning an agricultural sensor. The method may include one or more of the above-described inputs capturing or otherwise determining or providing information to controller 212. For example, the machine location may be determined in block 252; output may be captured from sensor 202 in block 254; material flow may be sensed in block 256; machine operational status may be determined in block 258; and one or more parameters regarding the last cleaning may be provided, such as via capture, determination, etc. in block 260.

Accordingly, the input information may be received by controller 212, illustrated at block 232. Received information may include, but is not limited to, machine location, material flow, machine operational status, and/or parameters regarding the last cleaning. Moreover, captured information from sensor 202 may be received. Implementations of the invention may include any one, two, three, four, or all of the above-described inputs. Moreover, other inputs may be included without departing from the scope of the invention.

The received information may be used to determine if one or more of a plurality of criteria or a combination thereof have been met that would lead to cleaning of the sensor 202. In the illustrated embodiment, in block 246, a plurality of criteria may be analyzed by cleaning control module 224, one or more of which may lead to cleaning of the sensor 202. A first criteria 234 may be whether the amount of obscurant is above a predetermined threshold. In one or more implementations, cleaning control module 224 may analyze information received from sensor 202. In one or more implementations such information may be an image. This analysis may include determining a characteristic of obscurant, which may be an amount or level of obscurant affecting the output of sensor. In implementations wherein the information is an image, the module 224 may be configured to determine an amount or level of obscurant on the sensor that is present in the image. If the amount of obscurant is above a predetermined threshold, the module 224 may activate the cleaning actuator 214. In one or more implementations, the module 224 may activate the cleaning actuator 214 if at least a certain percent of the image is obscured, such as 5%, 10%, 15%, 20%, 25%, 30%, 35%, 40%, 45%, 50%, 55%, 60%, 65%, 70%, 75%, 80%, 85%, 90%, 95%, or 100%.

In one or more implementations, at block 236, the cleaning control module 224 may analyze the material flow rate at one or more locations of the combine 100. In such implementations, module 224 may analyze information received from material flow sensor 204, such as that sent in block 256 and received in block 232. In some implementations, it may be advantageous to activate cleaning when material flow rate is low. Doing so may allow the cleaning to be more effective than at other times. Moreover, by activating the cleaning system when material flow rate is low, interference of the material and cleaning system with each other may be reduced and/or eliminated. In some examples, periods of low flow rate follow periods of higher flow rate. Because periods of high flow rate may result in increased amounts of obscurant on sensor(s) 202, cleaning may occur at a necessary time when material flow rate is low. Moreover, in some examples, the cleaning process may be impeded by a high flow rate. Accordingly, cleaning at a time of low flow rate may be more effective than cleaning at times of higher flow rates. In some implementations, one or more material flow sensors 204 may be used to determine if material is flowing. In some implementations, one or more material flow sensors 204 may be used to determine a rate of material flow. In some implementations, the one or more material flow sensors 204 may determine this information in conjunction with controller 212, while in other implementations one or more material flow sensors may determine this information without controller 212. Periods of higher flow rate may include, but are not limited to, when a machine is actively harvesting crop.

In one or more implementations, at block 238, the cleaning control module 224 may analyze the location of the machine, such as combine 100. In such implementations, module 224 may analyze information received from machine location input 208, such as that sent in block 252 and received in block 232. Information related to machine location may include, but is not limited to, whether the combine 100 is in a field and/or where within a field the combine 100 is located. With respect to where within a field the combine 100 is located, the cleaning control module 224 may determine whether the combine 100 is located at or along a field boundary, at or in the field headlands, in a location wherein the crops to be harvested span the maximum harvestable width of the combine 100 and implement 104, and/or in a location where the crops to be harvested span less than the maximum harvestable width of the combine 100 and implement 104. In some implementations, the machine location input 208 and/or the cleaning control module 224 may determine the machine location with reference to other systems of the combine 100. In some implementations, information related to machine location may be obtained from a GPS signal. In some implementations, information related to machine location may be determined from optical sensors configured to determine the machine location. For example, optical sensors may be useful to determine if the machine is in a field, outside of a field (including but not limited to on a road), in a harvested area, and/or in an unharvested area. In some implementations, the location may be obtained from machine systems related to producing and/or following a field map, as described above. In some embodiments, such a field map may include field boundaries, which may indicate whether the machine is inside of a field or outside of a field and/or within a non-crop or unharvestable area of a field. Moreover, such a field map may indicate whether the combine 100 is in an area that has already been harvested or an area to be harvested. In an area to be harvested, the field map may indicate whether the area includes crops to be harvested that span the maximum harvestable width of combine 100 and implement 104. In some embodiments, one or more of the above inputs or sources may be used to determine the machine location.

In one or more implementations, it may be advantageous for the controller 212 to activate the cleaning actuator 214 at a time when the combine 100 is harvesting a reduced amount of crop, including harvesting no crop or harvesting less than the full capacity of crop. By using the machine location input, the module 224 can determine when the combine 100 is expected to harvest a reduced amount of crop or no crop. For example, when the combine 100 is within the boundary of a field, the cleaning control module 224 may assume material flow; however, when the combine 100 is outside of the boundary of a field, the cleaning control module 224 may assume no material flow. Within a field, the cleaning control module 224 may analyze whether the combine 100 is actively harvesting crops from the maximum harvest width, whether the combine 100 is harvesting crops from less than the maximum harvest width, whether the combine 100 is located in an area that has already been harvested, and/or whether the combine 100 is located in an area that is yet to be harvested. As noted above, harvesting operations can create obscurant, including but not limited to dust and other debris. Moreover, it can be advantageous to clean sensor 202 when obscurant is minimized, which may lead to more effective cleaning. Therefore, in some implementations, module 224 may activate cleaning actuator 214 when combine 100 is at a location in the field where obscurant is reduced. In some implementations, module 224 may initiate a cleaning when combine 100 reaches a predetermined area in a coverage map, has been in a predetermined area in coverage map for a particular length of time, is likely to remain in a predetermined area in a coverage map for a predetermined period of time, and/or when the amount of obscurant is predicted to be reduced by a predetermined amount. In implementations where module 224 initiates a cleaning when combine reaches a predetermined area, such an area may include, but is not limited to, an area of a field wherein the combine 100 is harvesting or is expected to harvest crops from less than the maximum harvest width.

In one or more implementations, such as at block 240, the cleaning control module 224 may analyze the machine operational status, such as the operational status of combine 100. Machine operational status may be determined by machine operational status input 206, such as via a sensor, controller, or combination thereof. Machine operational status may include, but is not limited to, whether the machine is in a harvest state or a non-harvest state, whether the machine is unloading, whether the machine is in a transport mode, etc. In addition, machine operational status input 206 may provide input related to the specific status or stage of a particular operation, for example the status of an unloading operation, etc. It may be advantageous to activate cleaning actuator 214 at a time when the machine operational status indicates that a lesser amount of obscurant, such as dust or debris, is flowing near sensor 202. Such a time may include, but is not limited to, when the machine is in a non-harvest state. A non-harvest state may include, but is not limited to, when the machine is unloading and when the machine is in transport mode. In one nonlimiting example, the cleaning control module 224 may activate the cleaning actuator 214 when the combine 100 is turning during a harvesting operation, such as turning around on a headland of a field. In some harvesting operations, the combine 100 may be in a non-harvest state at such a time.

In one or more implementations, such as at block 240, the cleaning control module 224 may analyze at least one last cleaning parameter, including but not limited to the time of last cleaning, an amount of crop that has been harvested since the last cleaning, and/or the quantity of area harvested since the last cleaning. This input may be provided at block 260. It one or more implementations, it may be advantageous to clean sensor 202 after a particular amount of time, after a particular amount of crop has been harvested, and/or after a particular quantity of area has been harvested.

Cleaning control module 224 may activate cleaning actuator 214 to clean sensor 202 when one or more criteria or interlocks are satisfied, such as at block 248. As discussed above, method 250 may include a step of determining whether one or more cleaning criteria are satisfied, at block 246. In some implementations, the cleaning control module 224 may instruct cleaning actuator 214 to initiate cleaning if at least one of the criteria is met. In some implementations, the cleaning control module 224 may instruct cleaning actuator 214 to initiate cleaning if a combination of criteria, such as a predetermined combination of criteria, is met. If the result of block 246 is to clean the sensor 202, then cleaning actuator 214 is instructed or activated to actuate the cleaning apparatus(es), such as at block 248 of FIG. 3.

Controller 212 may determine how long to clean sensor 202. In one or more implementations, cleaning actuator 214 may cause the cleaning apparatus to clean the sensor 202 until a particular amount of time is reached, until a particular number of cycles is reached, and/or until a level of obscurant falls below a particular threshold. Other factors may be used to determine how long sensor 202 is cleaned without departing from the scope of the invention.

The cleaning actuator 214 may activate any type of cleaning apparatus to clean sensor 202. Examples include, but are not limited to, an apparatus that wipes the sensor; an apparatus that scrapes the sensor; an apparatus that provides fluid washing (e.g., air, liquid (such as water or solvent)); an apparatus that heats sensor (including but not limited to a lens); an apparatus that vibrates sensor, including but not limited to ultrasonic vibration; an apparatus that provides a dust repellent; and/or an apparatus that provides a water repellent.

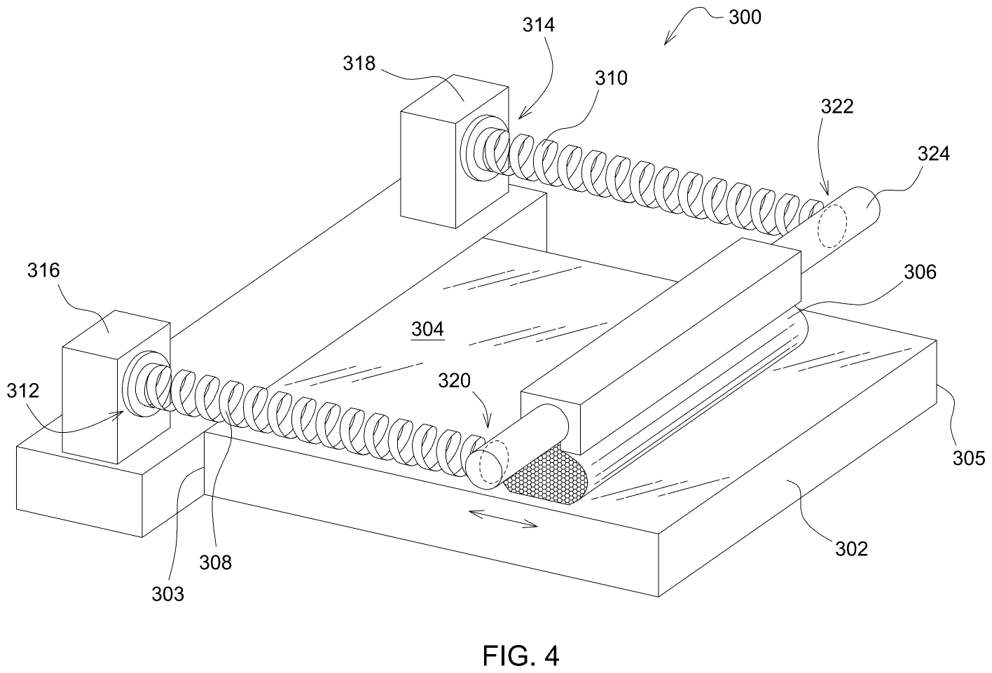

Referring to FIG. 4, an embodiment of a cleaning apparatus 300 is shown. Shown is a sensor 302. The sensor 302 may have a surface 304, such as a lens. The sensor 302 may further have a first end 303 and a second end 305. The apparatus may include a cleaning material 306. The cleaning material 306 may be any cleaning material that is capable of cleaning the surface 304, such as a lens, via the apparatus herein described. For example, the cleaning material may wipe the surface 304 clean. In some implementations, cleaning material 306 may be a cloth, lens wipe, scraper (e.g. plastic scraper, metal scraper), and/or foam. The cleaning material 306 may be joined, directly or indirectly, to at least one spring. The illustrated embodiment includes a first spring 308 and a second spring 310. The first spring 308 may include a first end 312 and a second end 320. The second spring 310 may include a first end 314 and a second end 322. The cleaning material 306 may be joined to the first spring 308 and second spring 310 in any manner known in the art. In the illustrated embodiment, the cleaning material 306 is secured to a link 324. The link 324 may be joined at or near a first spring 308 second end 320 and at or near a second spring 310 second end 322. Moreover, the first spring 308 may be joined to a first mount 316 at the first spring 308 first end 312. The second spring 310 may be joined to a second mount 318 at the second spring 310 first end 314. The first and second mounts 316, 318 may be positioned such that they retain the first and second springs 308, 310, respectively, on or near the sensor 302 surface 304. In some implementations, the first and second mounts 316, 318 may be brackets. Although the illustrated implementation shows two mounts and two springs, any number of mounts and springs may be used without departing from the scope of the invention, including but not limited to, zero mounts, one spring/mount, three springs/mounts, four springs/mounts, etc. Furthermore, the number of springs and mounts need not be the same (i.e. two springs may attach to a single mount, etc.)

In some implementations, sensor 302 will be configured such that when material flows through the machine, such as during an active harvesting operation in combine 100, material will flow from the sensor first end 303 in the direction of sensor second end 305. Moreover, in some implementations, the springs 308, 310 may be biased to retract toward sensor first end 303. In other words, the springs 308, 310 may be biased to retract toward mounts 316, 318. In some implementations, the springs 308, 310 may be configured to be extended by material flowing through the machine. Accordingly, in such an implementation, as the machine is actively harvesting, material flows through the machine and extends the springs 308, 310. As the springs 308, 310 extend to sensor second end 305, link 324 is also moved toward sensor second end 305. In addition, cleaning material 306 is also moved toward sensor second end 305. As material flow decreases and/or stops, springs 308, 310 may be configured to retract toward sensor first end 303. As the springs 308, 310, and therefore link 324 and cleaning material 306, move across sensor surface 304, sensor surface 304 is cleaned by cleaning material 306. Accordingly, as material flow decreases and/or stops, surface 304 will be cleaned by cleaning material 306. In some implementations, periods of material flow or increased material flow may cause obscurant on sensor surface 304. Accordingly, retraction of the springs 308, 310 may result in cleaning the surface 304 at one or more times of increased need. Of course, springs 308, 310 may be configured in an opposite manner, such that material flow causes retraction of the spring, thus cleaning the surface 304 in advance of increased material flow after a period of decreased material flow. Moreover, in some implementations, the cleaning material 306 may clean the sensor surface 304 as it moves in both directions, i.e. when the springs 308, 310 extend and when the springs 308, 310 retract.

Other cleaning apparatuses may be used without departing from the scope of the invention. For example, a cleaning material attached to an electric motor may be used to move across sensor surface to clean surface. The cleaning material may be a cleaning cloth, cleaning foam, cleaning brush, cleaning wiper, or any material that causes surface to be cleaned. Moreover, in some implementations, a nozzle for pressurized fluid, such as air, water, and/or solvent, may be used. In some implementations, sensor surface may be heated, such as via one or more nozzles that release warm air. In other implementations, vibration may be used to clean sensor surface. The vibration apparatus may be connected to one or more surfaces where dust accumulates. In one or more implementations, one or more apparatuses may be used to apply water or dust repellent to surface.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined, connected) are to be construed broadly and may include intermediate members between a connection of elements and relative movement between elements. As such, joinder references do not necessarily infer that two elements are directly connected and in fixed relation to each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

1. An agricultural machine, comprising:
said agricultural machine configured to perform a function that results in material flow in a first direction through said agricultural machine and wherein said material flow results in at least one obscurant in said agricultural machine;
at least one sensor, said sensor exposed to said at least one obscurant;
a sensor cleaning mechanism, comprising:
at least one spring configured to extend and retract;
at least one cleaning material;
said spring configured to move said cleaning material across a surface of said at least one sensor during at least one of said extension and retraction of said spring.

2. The agricultural machine of claim 1, wherein said spring extends in said first direction and retracts in a second, opposite direction.

3. The agricultural machine of claim 2, wherein said material flow in said first direction causes said spring to extend in said first direction.

4. The agricultural machine of claim 3, wherein at least one of stopping or reducing said material flow in said first direction causes said spring to retract in said second direction.

5. The agricultural machine of claim 4, wherein said cleaning material is configured to clean said surface when said spring retracts in said second direction.

6. The agricultural machine of claim 1, wherein said sensor cleaning mechanism further comprises a bracket joining said sensor and said spring.

7. The agricultural machine of claim 1, wherein said sensor cleaning mechanism comprises a plurality of springs.

8. The agricultural machine of claim 7, wherein said sensor cleaning mechanism comprises a plurality of brackets wherein each bracket joins at least one of said plurality of springs to said sensor.

9. The agricultural machine of claim 8, wherein said sensor cleaning mechanism comprises two springs each having a first end and a second end, wherein said first ends are joined to first and second brackets, respectively, and wherein said cleaning material extends between said second ends of said springs.

10. The agricultural machine of claim 1, wherein said material flow in said first direction causes said spring to retract.

11. The agricultural machine of claim 1, wherein said agricultural machine is an agricultural harvester.

12. The agricultural machine of claim 11, wherein said agricultural harvester is a combine harvester.
